(19) United States
(12) Patent Application Publication
(10) Pub. No.: US 2004/0124635 A1
(43) Pub. Date: Jul. 1, 2004

(54) Removable Quick Connection

(75) Inventor: Bernard Hall, London (CA)

Correspondence Address: CHECKFLUID INC., 4500 BLAKLE ROAD, UNIT #102, LONDON, N6L 1G5, CA

(73) Assignee: CHECKFLUID INC., London (CA)

(21) Appl. No.: 10/605,230

(22) Filed: Sep. 17, 2003

Related U.S. Application Data
(60) Provisional application No. 60/411,342, filed on Sep. 18, 2002.

(51) Int. Cl. F16L 37/00

(52) U.S. Cl. 285/305; 285/321

(57) ABSTRACT

The invention is comprised of a means of quick connecting a male and female member, typically used to transmit fluid or gas under pressure, using only a standard internal retaining ring while still allowing for disassembly.

### BACKGROUND OF INVENTION

The present invention relates to an improved removable quick connection used primarily for parts transferring pressurized fluid or gas.

Typically such connections have a male member with either a groove or cylindrical protrusion used to secure the connection, a female member with a groove for capturing the retaining element, a sealing element recessed in a groove in either the male or female member, and a retaining element.

Currently the retaining rings used are non-removable in nature and as such may never be replaced if they wear or break. Also, current designs either: do not allow later removal of the male member, have a separate locking or unlocking clip, use a separately energized retaining ring, or use a segmented retaining ring. One such example is the removable plug-in socket connection as shown in U.S. Pat. No. 4,613,172 to Schattmaier, that uses a separate locking clip, and a separately energized retaining ring that is segmented.

### FIELD OF THE INVENTION

The present invention relates to a removable quick connection, and method of producing said connection. More specifically, the present invention relates to a novel retaining ring and groove assembly designed for use in a pressurized fluid or gas connection, where the male member is secured into the female member.

### SUMMARY OF INVENTION

According to the present invention the male member of the connection is designed with the standard outside diameter to mate with the female half, according to the requirements of the sealing element. A groove is added to either the male or female member to secure a sealing element that will seal against pressurized fluid or gas. Another groove is added to the male member for the retention of the retaining ring with a groove diameter of slightly less than the internal diameter, not counting the lugs, of the fully compressed retaining ring, to allow for the compression of the retaining ring once the parts have been assembled. The male member is also designed with a cutout starting at the retaining ring groove and proceeding to the back end of the male member. This cutout is deep enough to line up with, and tangent to, the listed internal diameter, including lugs, of the retaining ring, when in the listed shaft diameter. This cutout allows access to the lugs for later disassembly and prevents rotation of the retaining ring. The female member is configured with the listed groove dimensions from the retaining ring manufacturer.

### BRIEF DESCRIPTION OF DRAWINGS

FIG. 1 is a cutaway view of a prior art removable plug-in socket connection

FIG. 2 is a cutaway view of the assembly

FIG. 3 is a principal view of the assembly showing the access to the retaining ring

FIG. 4 is a cutaway view of the male member showing the cutout, retaining ring groove, and seal groove

FIG. 5 is a cutaway view of the female member showing the retaining ring groove and lead in taper

FIG. 6 is a principal view of the standard retaining ring

FIG. 7 is a principal view of the sealing element

### DETAILED DESCRIPTION

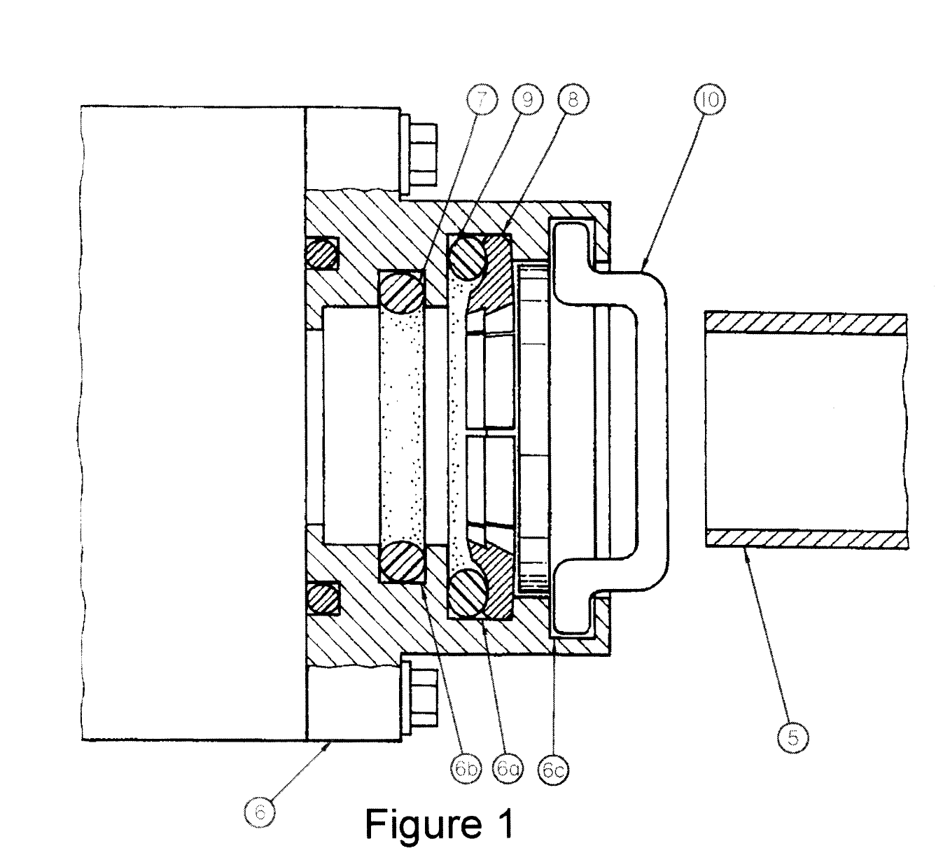

A commonly known removable plug-in socket connection is shown in FIG. 1. The connection consists of a male member 5, a female member 6, a sealing element 7, a retaining ring 8, an energizer 9, and an unlocking clip 10. The female member 6 is provided with a groove 6a to capture the retaining ring 8 and energizer 9. The female member 6 also contains a second groove 6b that captures the sealing element 7, and a third groove 6c that captures the separate unlocking clip 10.

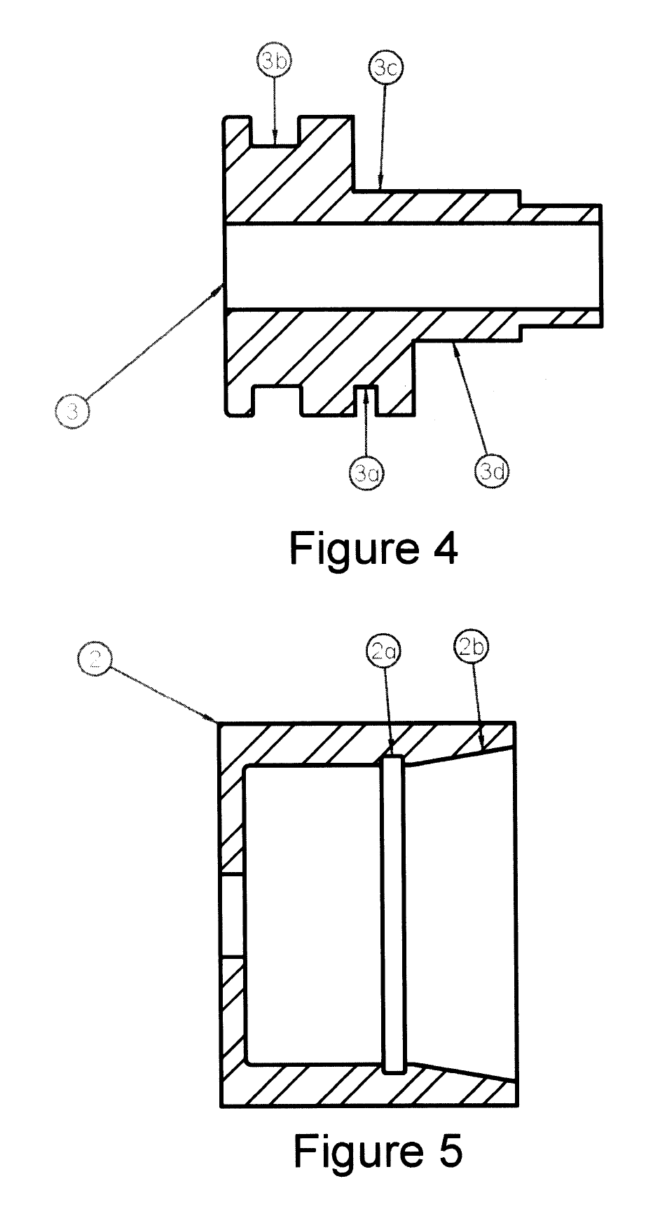

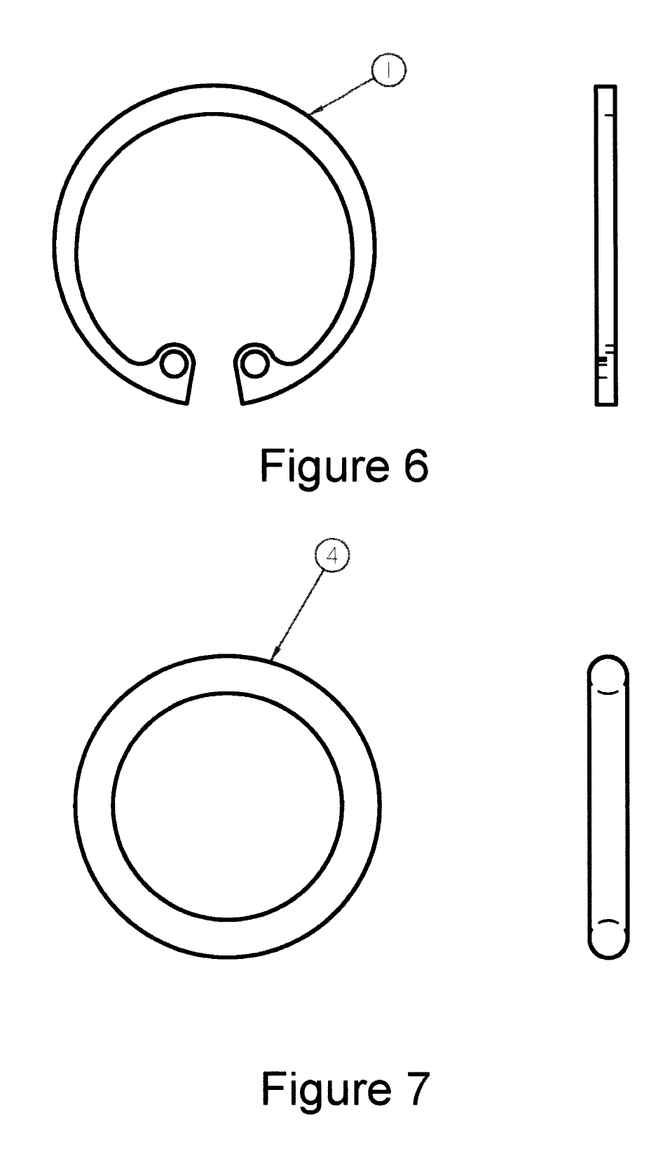

The present invention relates to an improved removable quick connection for use in the transfer of pressurized fluid or gas. In general, the connection system comprises of a simplified retaining ring 1 (FIG. 6), a sealing element 4 (FIG. 7), a female member 2 (FIG. 5), and an improved male member 3 (FIG. 4) with an improved groove 3a and cutout 3c arrangement.

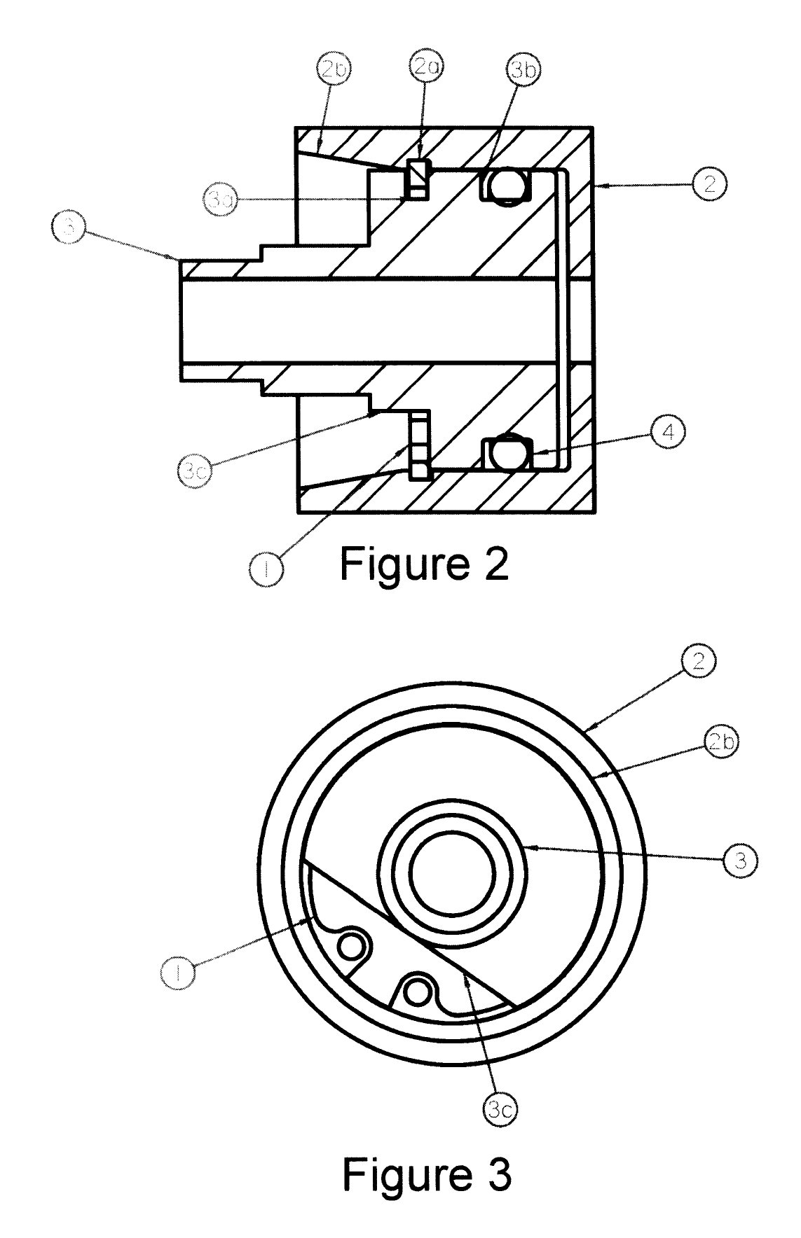

More specifically, the connection is shown as a cutaway view in FIG. 2. The female member 2 in a preferred embodiment has a taper 2b leading in to the retaining ring groove 2a to allow for easier connection. The male member 3 is configured with a groove to contain the sealing element 3b, used to seal against pressurized fluid or gas. The male member 3 also has a groove 3a to capture the retaining ring 1 on the male member 3 in preparation for connection assembly. The groove for the retaining ring 3a is designed not to allow the lugs of the retaining ring 1 to be accessible after insertion, however the cutout 3c allows for the lugs to be accessible and limits the orientation of the retaining ring 1 after it has been placed on the male member 3. The retaining ring groove 3a is designed to be deep enough such that, when the male member 3, with installed retaining ring 1, is pushed into the female member 2 the retaining ring 1 is able to compress to pass through the taper 2b on the female member 2, and the retaining ring 1 springs back to the diameter of the retaining ring groove 2a of the female member 2 when the retaining ring 1 enters the groove 2a. Once assembled the retaining ring 1 holds the male member 3 and the female member 2 together by means of the retaining ring groove of the female member 2a and the retaining ring groove of the male member 3a.

FIG. 3 shows, in a principal view of the assembled connection, the cutout 3c on the male member 3 that allows access to the retaining ring 1 after assembly of the connection. Having access to the retaining ring 1 allows for the retaining ring 1 to be compressed, through the use of retaining ring pliers or a similar tool, such that the male member 3, with the sealing element 4 and retaining ring 1 still captured, may be removed from the female member 2 in a reverse manner as to the method that was used to assemble the connection. Once the male member 3 has been removed from the female member 2, the sealing element 4 and the retaining ring 1 are left exposed and as such may easily be accessed for means of examination or replacement.

A clearer cutaway view of the male member 3 is shown in FIG. 4. The member is in a preferred embodiment configured with a trailing diameter 3d that is equal in radius to the distance of the cutout 3c from the center axis of the male member 3, to allow for easy access to the retaining ring 1 via the cutout 3c.

A simple cutaway view of the female member 2 in FIG. 5 shows the taper 2b leading to the retaining ring groove 2a of the female member 2. In a preferred embodiment the taper 2b has an internal diameter greater than that of the free diameter of the retaining ring 1, at the open end of the taper, to allow for easy alignment of the male member 3 and retaining ring 1 during assembly of the connection.

A more detailed view of the retaining ring 1, and sealing element 4 can be seen in FIG. 6 and FIG. 7 respectively.

The invention is described in an illustrative manner, and it is to be understood that the terminology, which has been used is intended to be in the nature of description rather than of limitation.

1. A retaining method for the interior connection of a male and female member comprising:
A standard internal retaining ring
A female member having a standard retaining ring groove
A male member having a shaft and a retaining ring groove, which when assembled with the retaining ring can be axially inserted into the female member, forming a simple connection.

2. A retaining method as set forth in claim 1 wherein either the male or female member also has a groove for capturing a sealing element to seal against pressurized liquid or gas.

3. A retaining method as set forth in either claim 1 or 2 wherein the female member has a gradual taper leading into the said retaining ring groove allowing for hand assembly, and thus creating a quick connection.

4. A retaining method as set forth in claim 3 wherein the male member has a retaining ring groove that is equal to or less than the internal diameter of the fully compressed retaining ring without consideration of the lugs, and a cutout of sufficient depth to allow access to the lugs. Thus, providing a means of removal of the said retaining ring and male member after assembly.
